(19) United States
(12) Patent Application Publication
(10) Pub. No.: US 2015/0181020 A1
(43) Pub. Date: Jun. 25, 2015

(54) System and Method for Utilizing Metadata Associated with Audio Files in a Conversation Management System

(71) Applicant: HarQen, Inc., Milwaukee, WI (US)

(72) Inventors: Jeff Fitzsimmons, Fox Point, WI (US); Pehr Anderson, Wauwatosa, WI (US); Kris Gosser, Milwaukee, WI (US); Matt Stockton, Milwaukee, WI (US); Kevin Lindberg, Shorewood, WI (US); Andy Winn, Endicott, NY (US); James O'Shaughnessy, Milwaukee, WI (US)

(21) Appl. No.: 14/460,998

(22) Filed: Aug. 15, 2014

Related U.S. Application Data
(60) Provisional application No. 61/866,250, filed on Aug. 15, 2013.

(51) Int. Cl. H04M 3/22

(52) U.S. Cl. CPC H04M 3/2218

(57) ABSTRACT

A method for managing a conversation stream being recorded contemporaneously with the conversation in which at least one participant is engaged in a discussion and wherein the at least one participant is communicating with the aid of a computer enabled interface for placing metadata tags, flags and notes in a file associated temporally with the audio stream of the recording. The method includes the steps of recording a live audio conversation in a recorded audio stream created contemporaneously with the discussion among or between conversation participants, generating at selected times contemporaneously with the recording step associated metadata representing specific points of interest, and analyzing the metadata to extract management information pertinent to the audio conversation.

### CROSS-REFERENCE TO RELATED APPLICATIONS

This application claims the benefit of U.S. provisional application 61/866,250 filed Aug. 15, 2013 hereby incorporated by reference.

### BACKGROUND

The present invention relates generally to conversation management systems and more particularly to the utilization of metadata associated with a recorded audio stream. This invention is an improvement over those disclosed and claimed in co-pending U.S. patent application Ser. No. (1732.020), Ser. No. 13/313,900 filed Dec. 7, 2011, Ser. No. 12/144,412 filed Jun. 24, 2008 and Ser. No. 13/163,314 filed Jun. 17, 2011, all assigned to the assignee of this invention and incorporated by reference.

In our U.S. patent application Ser. No. (1732.020) and Ser. No. 13/313,900, we disclose methods and systems for managing voice conversations using metadata associated with recordings of them. In some cases the metadata is applied generally contemporaneously with the conversation and in other cases it is applied thereafter. In either event, whether synchronous or asynchronous, the metadata fosters rapid and efficient navigation of the recorded conversation and that, in turn, leads to high efficiencies when doing so.

We have since discovered the value of mining the metadata. Whereas the utility of the metadata associated with a single conversation is significant as a navigational tool, when evaluating and analyzing the metadata associated with two or more recorded conversations the utility is magnified. Moreover, as the universe of recorded conversations becomes greater, the advantages multiply multifold. We have also discovered the value of incorporating database information into the analysis. The databases may be internally organized within the host organization and/or public databases easily accessible via the Internet. We have still further discovered that any of a number of images, documents or even quasi-tangible objects can link conversations such that those images, documents or objects may systematically mediate one or more points of interest within the universe of recorded conversations. From this, we have discovered that the enterprise may realize substantial value from the analysis and evaluation of the metadata stored along with its recorded conversations.

Conversations are the core of effective and meaningful communication. This is true whether the conversations take place in one's personal or profession/business life.

Recent years have witnessed an explosion of communication tools and methodologies. Nevertheless, live voice remains the predominant mode of effective communication. For example, VOIP services promote their offerings based on the richness of live voice communications over email or other forms of static messaging. This is at least as true in the world of business and the communications that underlie commerce. (See Videoconference Disconnect, Information Week, June 2012) Based on rankings, email is employed by 91% of persons when colleagues communicate while voice (phone) is used 88% of the time. That is augmented by face-to-face meetings conducted 38% of the time. In downward rank order, videoconferencing weighs in at 16% with contact centers (inbound and outbound) at 15%, instant messaging at 14%, in-person visits to retail at 12%, fax at 7% and all forms of social media merely 3%, when interacting with those in strategically important business relationships. Isolating those interactions which are based on or implicitly engaged in live voice communications, that category is by far the most important when combining phone, the audio track of a video conference, call centers and in-person visits.

While having a high ranking in importance, voice is also the most difficult to reconstruct when one needs to recall information exchanged in this manner. Many people simply rely on memories while others make notes in an effort to capture essential points or to refresh a poor recollection. Notes often attempt to record the essence of what is said to be used to refresh the note-taker's recollection later. In the process, more time can be devoted to note taking than actually listening to the speaker. However well intentioned, neither memory nor note taking has proven to provide highly accurate preservation of the conversation and that is especially true with the passage of time.

As a hedge against the aforenoted problems, live conversations have been preserved via audio recordings to permit consultation at a later time. Few of those recordings are ever reviewed afterwards. This is due to the unsurprising fact that audio recordings are difficult to review when one is interested either in refreshing a recollection of something specific that was said or searching for a part of a conversation to learn what was said. Once again, with the passage of time these factors can become overwhelming as the searcher's memory dims and the linear search through the conversation devolves into simply listening to the entire recording to winnow out the important segment(s).

Generally speaking, when considering either business or personal conversations, communication can be defined as an interaction, usually between or among two or more parties, during which information is presented or exchanged for the purpose of causing or catalyzing some form of action, including the act of remembering or recalling the interaction. There are many variables in this representation of the commonplace act of communicating.

The interaction may be synchronous or asynchronous. In other words, the interaction may be live (real time) or it may be displaced in time (with at least a part of the interaction having been recorded at an earlier time or archived in some fashion).

The interaction may be between a person and a machine, such as a computer, computer terminal, smart phone, net appliance or any of a host of other devices capable of conducting the presentation or exchange. In that sense, the machine may become a proxy for another person or party in the interaction handling the timing, segmenting, sequencing and playback of previously recorded human audio into the current conversation or capturing the current conversation for later review or possible participation in a future conversation event. This mode of interaction might be useful, for example, when the conversation is to become a presentation to be made at a later time or to be used in an asynchronous interview (e.g., an employment interview) or the like.

When two or more parties participate in the communication, some or all of them may be co-located or they may be remote from one another. Thus, there is no requirement that participants in the interaction be together in the same place or participate at the same time. Relaxing any of these constraints broadens the environment in which the voice interaction may take place.

The setting of or environment for the interaction is limited only by the ability of the person(s) to engage in or observe the presentation or exchange at some point in time. Provided the interaction can be accomplished, the setting or environment is not a limitation except in that functional sense. The most commonly anticipated setting is a business setting and, in that environment, an office or conference room is undoubtedly the most regularly encountered.

Along similar lines, the setting or environment typically will exhibit adequate power for apparatuses to be used and connectivity so those apparatuses may interact during the conversation event. These electrical/electronic resources may be fixed in whole or in part as one would typically encounter in an office or may be self-contained in whole or in part in the apparatus(es) as may be expected in battery-powered devices.

U.S. patent applications Ser. Nos. 13/313,900 and (1732.020) have improved the efficiency and effectiveness of live voice conversations in part by applying metadata to the captured audio stream. The metadata may be in the form of tags that are applied to the audio stream either automatically or by participants in the conversation. Tags may represent speakers as they each take turns in contributing to the conversation. In this way, a later search for the comments or contributions of a particular speaker can be facilitated. Other tags may be associated with agenda items and in a similar fashion those of particular interest can be identified easily. User defined and applied tags can include, among others, identifiers for a participant's or listener's concerns or identify portions of a conversation thought to be important or inspirational. Still other tags may be associated with a particular follow-up item such as the familiar “to-do.” Tedious linear searching is no longer required when a searcher can efficiently home in on a speaker, an agenda item, an interest or concern flagged as an element of the preserved audio stream.

U.S. patent application Ser. No. 13/313,900 further improves the efficiency of voice communication by providing participants in the conversation the ability to add notes to the audio stream. Those notes may be a reaction to something said during the conversation or may record a participant's impressions. Just as people make notes during discussions, the system of (1732.020) facilitates similar note taking. However, what is manifestly different from other note-taking situations, no one needs to take a note to remember what another person said—that is captured in the audio stream to which notes, flags and tags are applied. This frees up the time and distraction of note taking for anything other than short or terse comments participants find interesting or concerning. In turn, concentration and attentiveness improve.

### SUMMARY

The metadata associated with a recorded audio stream is a robust source of further information concerning both the content and context of a conversation. As participants realize the benefits that follow from mining that metadata as described herein, they are influenced to add even more to the audio stream to increase those benefits to them. Thus, the present invention fosters a virtuous cycle enjoying positive feedback; as users realize the benefits of the instant system they are increasingly likely to employ it more frequently to enjoy those benefits.

The overwhelming majority of conversations are conducted with both intrinsic and extrinsic contexts. Just a few include (a) the reason for the conversation, (b) who is talking during the conversation and conversely (c) who is a silent participant during multi-party discussions such as a business conference call, (d) whether if at all are various participants related, (e) whether this same group of participants or conversants or a subgroup from among them (such as a community of practice) previously engaged in conversations and, if so, (f) the topics discussed and any relationship to the one currently being conducted (g) the identity of active participants during the conversation, both as a speaker and as a note taker or tagger, among other contextual elements that may be pertinent depending on circumstances. All or any of these aspects may have metadata associated with them. Other metadata may include that associated with words spoken and the frequency with which they are used, the time each participant joined the conversation and the length of time each speaker contributed to the conversation. One who adopts the system and methodology of the present invention may add other points of interest believed to be statistically relevant to the purpose for which the conversation was conducted either alone or in combination with other conversations, such as those around the workplace. Thus, the audio files of these recorded conversation streams (sometimes referred to as “voice conversation events”) are rich with metadata.

Creating and capturing the metadata associated with a conversation facilitates its further analysis and its fit within a broader business ecosystem in which conversations carry the vast majority of important and essential business information. Data mining algorithms can extract information including some too subtle for participants often to recognize themselves.

For example, subject matter or domain knowledge or expertise is often crucial to a successful discussion and outcome of a business conversation. By identifying the participants invited to a meeting, and using tools to examine their backgrounds and relevant experience, the system can rate the probability of success of the meeting. This analysis can be conducted one-off but there are other ways to improve the predictive accuracy using heuristic analyses of similar meetings in the organization including prior meetings of the same group. If there is a probability a meeting is unlikely to provide optimal results, the organizer can be prompted to add other participants having background, skills and/or experiences that are likely to improve the outcome.

Yet too, mining metadata from a range of meetings may indicate there are several addressing the same or closely similar topic. This may be purposeful in some cases to gain added diversity of opinions but all too often it is mere duplication resulting from poor communications among those most interested in the topic or subject matter. If a similar meeting was previously conducted, the user can be notified and notes from that meeting queued up for her review or indeed the entire audio file may be sent directly to her. In this fashion, a group can build on the outcomes of one or more prior meetings rather than repeating efforts and learning unnecessarily.

The prior summary illustrates how data mining metadata can be useful in prompting a user automatically. Equally apparent from that description, a user may query the system to extract the same or similar useful information using conventional search tools and terms. For example, a manager having been assigned a new task or project can readily search conversation metadata from prior meetings or conversation events to determine whether and to what extent the firm has previously addressed the same or similar subject matter. If so, she can retrieve the recorded conversations (along with recorded or embedded metadata) or simply the snippets of conversation relevant to that task.

In another manifestation of the present invention, a repository of metadata-tagged audio streams representing the conversation history of an organization can be employed either reactively or proactively. When a user is contemplating placing a telephone call or sending a message to a person in another organization, a list of prior contacts with that same person can easily be generated based on a query or this can be done automatically. The list would include all others in the organization who have previously made contact with the identified person and information pertinent to their prior encounters. Links to audio snippets, either contextual or non-contextual, can be provided, again either automatically or at the user's request. Documents may be tagged that are potentially relevant, such as confidentiality agreements previously executed between the user's organization and that of the person to be contacted. Other contractual documents may similarly come into play. Summaries of those prior conversations may be helpful in myriad ways as well.

Likewise, a control or widget on a user's computer interface may allow him to associate the repository of enterprise conversations with websites, whether Internet, extranet or intranet. For example, a user studying a web page may use a widget to query the repository of metadata-tagged enterprise conversations either generally concerning the content of the page or some specific part of it to learn who else in the organization has discussed it at a point of interest to the user.

The system and methods of the present invention can assist those who cannot attend certain meetings. As mentioned above, a person can retrieve the audio file and listen to all or selected portions of it, the latter aided by associated metadata. Moreover, employing the data mining techniques of the present invention, there may be a high correlation between the user's interest, concerns, historic actions and specific topics or speakers. The present system and methods identify those correlations and present the user with audio snippets relevant to those topics or speakers. Moreover, the system can crawl though the repository and highlight for the user's review other snippets or full conversations having a high correlation factor so the user is able to draw from other meetings she was unable to attend but which bear on her current interests, concerns or responsibilities.

In addition to identifying correlations by analyzing metadata, the system and methods of the present invention can draw inferences and act accordingly based on a user's history of interactions during conversations. These systems and methods can determine relationships between and categorizations of distinct conversation events by analysis of associated metadata or inferred from events themselves. For example, when a participant tags the discussion of a one speaker with specific notations, such as an identification of high importance statistically more times than other speakers, the system may infer that the user is more interested in hearing the contributions of that speaker and that the user finds those comments more important. Thereafter, the system can flag contributions made by the speaker whether in the same or different conversation events and send messages to the user for his later action. Similarly, if another user invariably reviews a data point in a specific format, the system can readily infer that certain data points and their representations are most important to this user. The same is true in the way data points are shared among colleagues, allowing the system to make inferences and send appropriate data or tools to users based on their histories.

Because inferences are not as strong as correlations they may not be as reliable an indicator. However, users can filter or revise inferences and the system can adapt to those user inputs to become more valuable over time. Whether inference or correlation, a manager with proper authority may confirm the accuracy or note an inaccuracy and that notation can become part of a participant's file. For example, the system may infer that Joe has expertise in the field of airfoil design. Joe's manager may confirm the inference and that confirmation then is tagged to Joe. Then, in the future, the system will act on Joe's expertise in airfoil design as a fact rather than an assumption. Contrariwise, Joe's manager may understand that Joe has no special background in airfoil design and counter the inference or correlation if that action is appropriate under the circumstances. In any event, by confirming or refuting the accuracy of inferences suggested by the system, it “learns” the information and records it with greater accuracy, thereby rendering the system more useful over time for those who use it.

Another action to aid those not attending a meeting is enabled by analysis of metadata associated with a conversation stream or event. One can envisage having been omitted from the invitation list to a meeting yet have the conversation turn to them either by name, function, responsibility or capability. The system and methods of the present invention can match the participant list with a larger directory of personnel, their backgrounds and relationships to a given conversation. Performing a gap analysis, should a gap be identified, the system can take or prompt any of several actions. In one variant, the system may determine whether the person is important or essential to the probable success of the meeting and, if so, determine whether she is available to join. The system will flag this information for the meeting organizer or convener. If the situation is of a lower priority, the system may simply notify the omitted person after the conversation and send a note with or without the pertinent audio snippet. The absent person may be tasked with a to-do and the system sends that message along with any background audio from the conversation necessary to fulfill that task. For example, if during the course of a meeting another meeting is scheduled requiring certain participants to travel, in that case their respective administrative assistants will receive a message identifying the task of arranging travel along with the audio snippet containing the discussion of the trip. In this example, this snippet would include details needed to book the necessary travel and accommodation arrangements as they happened in the meeting rather than secondary notes interpreted and sent as a separate request.

Along similar lines, a meeting participant may be required for only a portion of a meeting. Rather than attend the entire meeting this type of participant can be put into a standby role and called to the meeting at the appropriate time. This standby participant may be granted authorization to review the entire audio file of the meeting or selected portions of it, such as the segment concerning his participation.

Metadata may aid in expected housekeeping typical of many business meetings. For example, a meeting may be scheduled for one hour. As time approaches the closing time for that meeting, the system may alert the organizer to reschedule a follow on meeting while participants are present and can review their calendars. Indeed, for those participants associated with the enterprise within which the conversation management system resides, enterprise servers can readily determine the optimal time for that follow on and schedule it, including any required rescheduling of conflicting meetings. Many meetings include follow up action such as the familiar to-do lists. Depending on the nature of those to-dos, appropriate messages can be sent automatically (to make travel arrangements, for example, as noted above) and to populate to-do lists for those participants having subsequent actions to take.

The conversations for which the present system and methods are adapted include those where all of the conversants are at the same physical location, such as a conference or meeting room, or as more routinely happens when the conversants are distributed geographically at several locations. The system of the present invention is appropriate for use in either situation. Thus, for example, when all participants are co-located the host will access the system via the system dashboard and record the conversation using any convenient device, such as a conference phone, a microphone in a computer such as a laptop or a mobile or smart phone. In this way, the conversation is captured and all of the system features are available to those logging onto the system.

It is envisioned that any of the participants, including those at remote locations, will be able to participate via a browser whether in a portable computer (laptop or tablet) or smartphone and interact using a dashboard provided via a central computer or server. Alternatively, a participant in a conversation may join simply via an audio link and not through a browser. Such a participant will lack the dashboard provided by the system of the present invention under those circumstances. Despite the inability to access the library of flags, etc., or the notes features, that participant may later retrieve the audio file and navigate through it using metadata applied by others during the conversation.

Those skilled in the art will understand that a principal feature of the present invention is the analysis of metadata created contemporaneously with the capture of a conversation in an audio file, wherein the metadata is generally time synchronized with the conversation stream and preserved with it for later review and analysis. Preferably the metadata is part of the captured audio file, but it is equally envisaged that the two files may be separate but capable of synchronous playback. Thus, it is the ability to recover for review and analysis the metadata associated with a conversation in a way that enables playback of the audio correlated with the metadata and not the physical or electrical association of these elements.

In other instances, the metadata may not have a wedded time relationship with the spoken conversation but nonetheless it is preserved with an effective linkage to the related conversation. For example, a participant may add a note or comment to the audio file that relates back to a previous segment of the same conversation. Likewise, a participant may make a mental connection with another, distinct conversation than the one in which she is then participating and add a note or comment relating back to the distinct file. These ancillary notes or comments are generally time synchronized with their insertion into the file at the time the note or comment is created despite their lack of synchronization with the segment of either the same conversation or even separate conversations altogether. When the user includes in the note or comment sufficient detail for the CMS to identify the substance to which the note or comment refers, that substance can be retrieved for playback later. In other words, the CMS is able to cross reference comments, notes, conversations and conversation event elements so a user may later have access to the audio files that inter-relate to common topical information.

A particularly helpful aspect of the system of the present invention is the ability to use documents, files, images or other objects (voice conversation elements) to mediate conversation events. For example, a particular document or object may be used by an organization many times and perhaps by many different persons. The CMS is capable of unifying the conversations where the, e.g., document has been used or presented and gather data about the document, the meetings when used and its effectiveness. For a sales team, this information may become highly important as their sales presentations evolve.

Other details and aspects of the present invention will become apparent from the detailed description and examples of use, which follow below.

### BRIEF DESCRIPTION OF THE FIGURES

FIGS. 1A and 1B are a flowchart illustrating the principle elements of the system and methodology of the present invention and their interrelationships;

FIG. 2 is a sample screenshot of a sample meeting invitation illustrating the information that may be included by a meeting originator;

FIG. 3 is a screenshot of a sample invitation received by an invitee to a meeting;

FIG. 4 is a screenshot illustrating a dashboard for a meeting participant as a meeting is underway;

FIG. 5 is a further developed screenshot, similar to that shown in FIG. 4;

FIGS. 6A and 6B and 6C are screenshots illustrating the sample dashboard a reviewer might use to navigate a recorded voice conversation event and its associated event elements, including metadata aids to navigation; and,

FIGS. 7A and 7B are a flowchart illustrating an example of how the present invention may be used to analyze the subject matter expertise of selected meeting participants in comparison with agenda elements.

### DESCRIPTION OF PREFERRED EMBODIMENTS

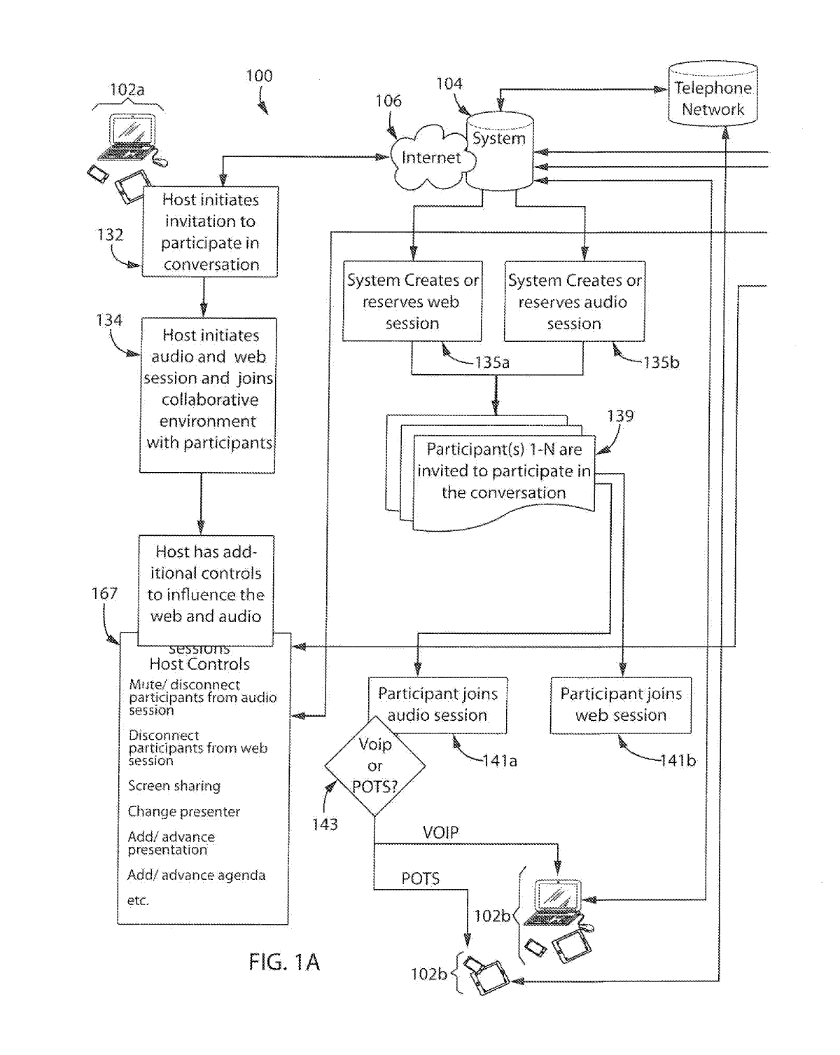

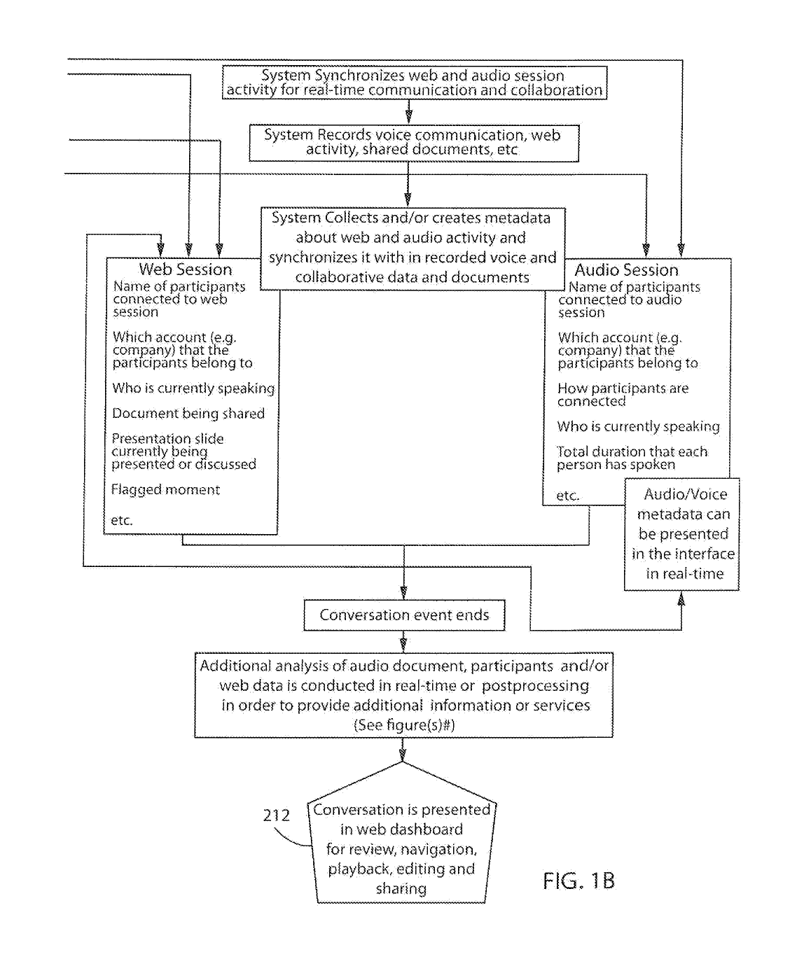

Referring to the flowchart diagrammed in FIGS. 1A and 1B, a conversation management system 100 (CMS) of the present invention is comprised of an input device 102a, in operative communication with control system 104 via a networking medium 106, in this instance shown to be the Internet. Other networking modalities may be used with equal effectiveness such as an organization's Intranet. The CMS of the present invention is agnostic to the specific networking modality or protocol; it is the function of networking that underlies this aspect of the inventive system and methodology. The input device 102 may be selected from the group consisting of computers such as desktop, laptop or tablet computers, and telephonic devices such as cell or smart phones. The control system houses executable code in the form of one or more computer programs that drives the CMS and is preferably a server; however, any appliance having logic, non-transitory memory and storage can hold the programs and be adapted to serve as the control system 104.

The CMS illustrated in FIGS. 1A and 1B is shown as a standalone system and will be described below in that contextual operation. Those skilled in the art will readily appreciate that the CMS may be an overlay on existing conferencing systems and thus be readily adapted to any one of a number of proprietary systems as an integral set of elements that allows for the improvements and advantages described in detail herein.

A conversation to come under the control of the CMS is initiated by a manager via any one of the workable input devices, such as the manager's laptop. Logging onto the CMS via the Internet, the manager enters a CMS portal having control functions consistent with the manager's status in the system. For illustrative purposes, the manager will have full access to the functions and features of the CMS following entry of identifying information which may be user name and password.

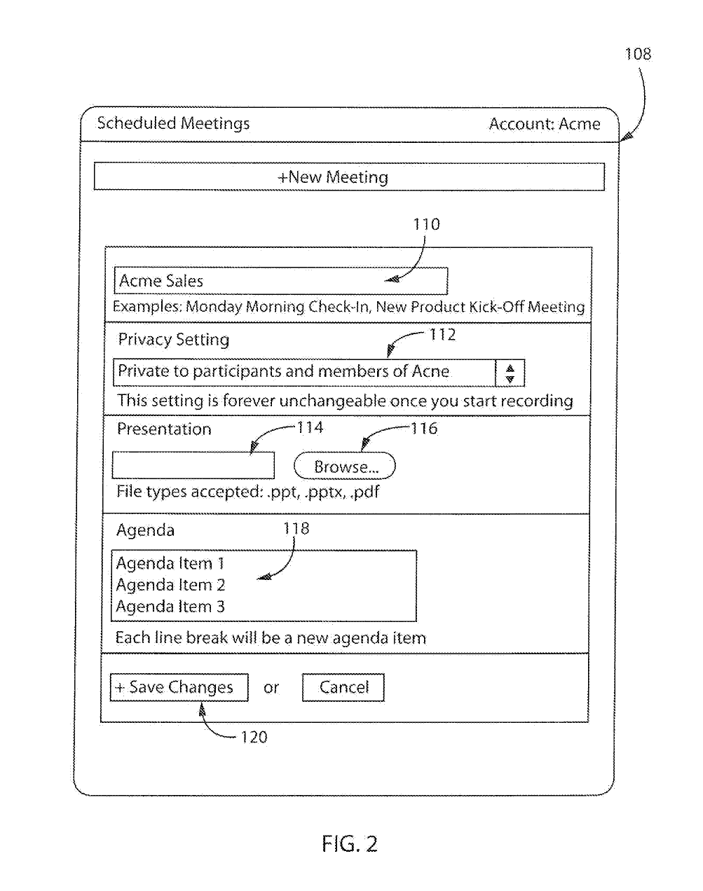

When the manager accesses the CMS, a dashboard 108 appears on the screen of the input device 102 as illustrated in FIG. 2. This dashboard will serve as a meeting invitation to selected meeting participants, as described below. The dashboard presents a place 110 to name the meeting with a shorthand description, such as Acme Sales Meeting, to identify that particular meeting and differentiate it from others in the system. The next field 112 allows the manager calling the meeting to set its privacy restrictions, such as only company employees or only a sales team, whatever is appropriate under the circumstances. The manager having meeting control can include presentation materials such as a PowerPoint® slide decks, documents, images and other supporting materials to be reviewed before or during the meeting, identified in window 114. A “Browse” button 116 facilitates the manager's selection from a library at the manager's disposal for these purposes, such as materials stored on the manager's computer or accessible through the firm's web. The last window shown on the dashboard of FIG. 2 is the agenda window 118 in which the meeting agenda can be described or uploaded as the manager may choose. As soon as the manager is satisfied with the content in the dashboard, s/he can create a meeting by clicking on button 120 or, optionally, “cancel” the meeting notice as an option suggested in this screenshot.

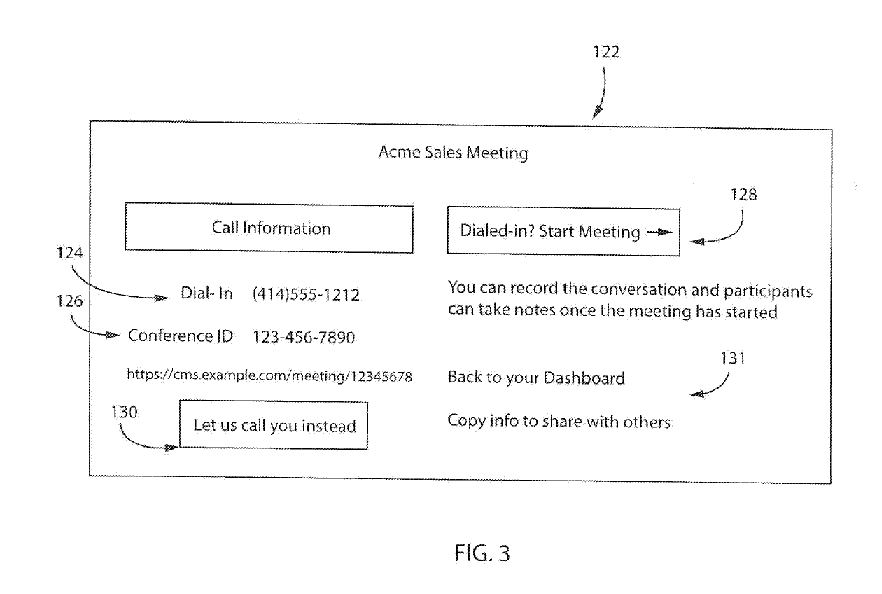

Having set up a meeting event, a meeting screen 122 is created as shown in FIG. 3. This screen contains the information to serve as the meeting invitation. The invitation process has several alternative paths as implied directly from FIG. 3. The manager can choose to send the unique meeting identifiers to participants which they can use after logging onto the CMS 100 to join the meeting. These consist of a dial-in telephone number shown in window 124 and a conference id number in window 126, unique to the scheduled call (here the Acme Sales Meeting). Alternatively, any participant may elect to log on to the CMS and view meetings scheduled for him or her and join by clicking on active window 128. Navigating to the meeting for the Acme Sales event, those individuals who wish can choose to have the control system 104 initiate the call at the start of the meeting. This feature is elected by clicking on the button 130, labeled “Let us call you instead.” The meeting frame 122 also includes an option noted as 131 in FIG. 3 giving the user the ability to return to his dashboard and/or copy information to share with others during the meeting. Still other options can be included as desired by those skilled in the art. Regardless, the step for sending the invitation is shown in block 132 of FIG. 1A. Block 134 captures the actions once participants are joining.

The host may initiate the meeting as a web session and/or an audio session. Having made the selection, the control system then either creates or reserves the appropriate session configurations as illustrated at blocks 135a and 135b in FIG. 1. If the meeting is scheduled for immediate access by participants, it is created; if the meeting is set for a future time it is reserved.

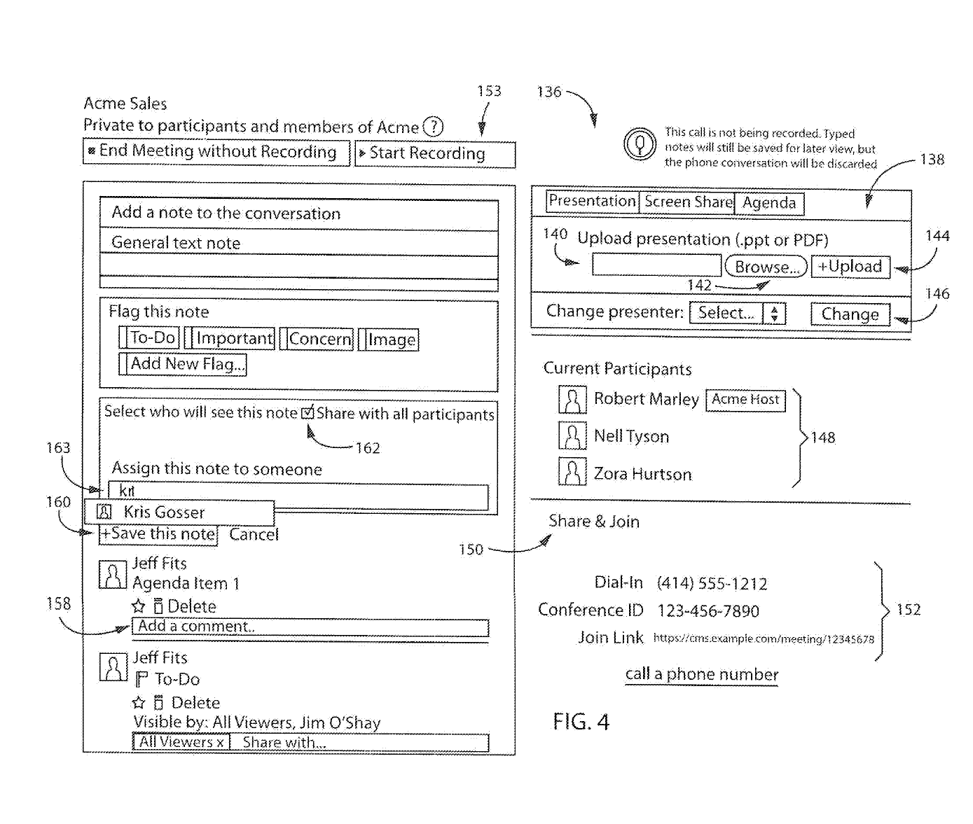

Participants may be assembled together in a meeting or conference room and the CMS employed to manage and record the discussion between or among them. Alternatively, some participants may be geographically dispersed, one or more in a conference room and the others at different locations. Regardless, invitees to the meeting log onto the CMS and are presented with a display screen such as the one illustrated in FIG. 4 as 136. A block 138 allows meeting participants to view any of a number of alternatives throughout the meeting, to be elected by mouse or pointer action on the alternatives shown for example as “Presentation,” “Screen Share” and “Agenda” within a sub-window 137. Presentation materials may be uploaded by indicating the path in window 140 or by browsing the files where they have been saved via the “Browse” button 142. However the window 140 is completed, the “Upload” button 144 serves to execute the command. Participants may navigate among the choices of Presentation to follow, for example, a PowerPoint® deck, or Agenda to see the continuing progress of the meeting.

Meeting participants may join the meeting session using any of the same or similar devices described above for the meeting host or originator. The devices are indicated as 102b in FIG. 1A. Participants may join as a web session or audio session as shown in the paths to blocks 141a and 141b in FIGS. 1A and 1B and when electing the audio session may join the conversation via either a POTS or VOIP connection. In some cases, a participant will join a meeting using both pathways to gain a high quality audio experience while being provided with the navigation tools described herein.

When presentation materials and/or agenda documents are uploaded into the CMS, the CMS itself autotags the materials in a synchronous fashion as the materials are discussed throughout the conversation. For example, as a deck of slides is presented, each slide has an autotag associated with it for later navigation to that segment of the conversation. Likewise, as the meeting leader progresses through the meeting agenda, each item is autotagged so those with access to the recorded conversation stream may readily isolate those agenda items of interest or concern to them without the need to listen to the entire recording to recover snippets they wish to hear. This is an especially important feature and benefit when the conversation moves back and forth to previously discussed items, which now appear at various locations throughout the conversation stream. Without having tagged those events, a later listener might well miss important topics of conversation or be required to listen to an entire recording just in case an item of interest is discussed in more than one segment.

Throughout the meeting the organizer may wish to share her screen with another participant or yield screen control to another in the meeting. This is achieved by appropriate selection and election in window 146. It is facilitated by the roster of participants displayed in listing 148, showing who is online for the meeting and their affiliation, beginning with the meeting host or convener and those who have entered via screen 122.

It sometimes occurs in a meeting that a participant was omitted from the list of invitees and that the omission is not apparent until the meeting is underway. As will be seen, once those in the meeting realize or are prompted that another participant should be invited, the CMS checks the calendar for that person and can issue the invitation if he is available. Alternatively, the host or another participant with executive privileges can initiate the invitation with the “Share & Join” field 150 which transmits to the desired invitee the meeting data listed in field 152.

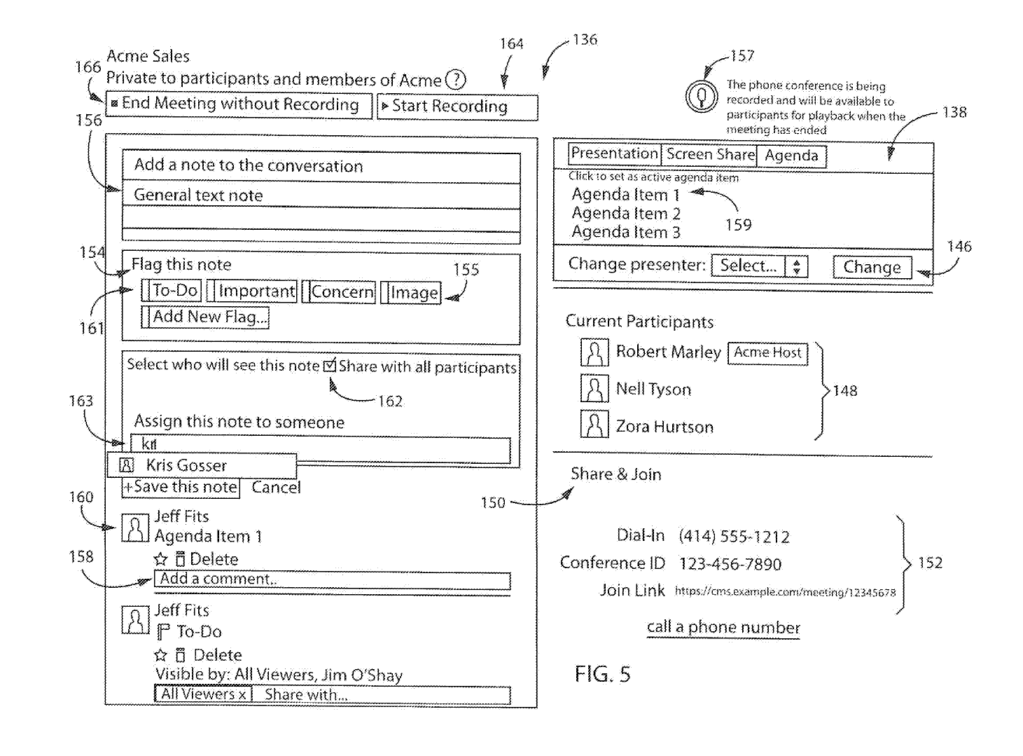

During the course of a meeting participants are provided with several tools to enhance their ability to add content to the conversation that fosters later navigation and retrieval, as best visualized in connection with the screen illustrated in FIG. 5. This figure shows a meeting in progress from the time the participants joined and were first presented with the dashboard shown in FIG. 4. Thus, the same windows are identified with the same reference numerals in both figures.

There are three active areas for a participant's interaction. The first is a library of flags or tags in a window 154. This library can be built to suit the nature of the conversation. In the present example of the Acme Sales Call, the listing of flags and tags will typically include “Important,” “Concern” and “Image,” along with a flag for “To-Do.” The meeting originator may also add flags correlated with the purpose of the meeting; e.g., for the Acme Sales Meeting, she might include flags labeled “Pricing,” “Delivery,” “Terms,” and the like. As the conversation is ongoing, a participant may insert one or another of these flags at any point where the participant believes such an identifier is appropriate and may do so as simply as “clicking” on the flag with a mouse or other pointing device or tapping on it when using a touchscreen. These identifiers permit the participant or any other reviewer to return to the recorded conversation stream and locate all those snippets where, for example, pricing was discussed and eliminates the need to record a separate note to identify those segments of the discussion. In turn, participants may devote greater attention to the conversation itself having been relieved of the need to make notes by the simple action of clicking on a tag or flag.

A second active window 156 provides a space for a participant to take notes, record impressions or otherwise annotate the audio file with contemporaneous comments. Whereas the flags and tags of window 154 are generic to the nature of the conversation, the notes field of window 156 permits customized annotations.

A third active window 158 allows participants to comment as the conversation develops. For example, if the agenda cues up the topic of price quotation, or “Quote,” that heading will appear in an activity stream box 160. As the conversation proceeds, any participant may comment on the discussion. This feature is analogous to the notes window 156 but is keyed directly to the specific topic under consideration at the time. A participant may also pick up a flag or tag from the library in field 154 and insert the same as shorthand for a comment. The comment windows build throughout a conversation, for example as the sales meeting progresses from price quotation to an agenda item for “Delivery,” a corresponding new set of activity stream windows will appear above the Quote section, and the same annotation options provided to the participants concerning that topic.

While the host has tools to share presentations and documents, many conversations require the participants to share supporting information as well. To that end, the system allows participants to insert documents or images into the conversation timeline as conversation elements for discussion and collaboration. Not only are the documents or images archived with the conversation, they are easily found and can be reviewed later in the context of the conversation. For example, if a product manager is discussing the new packaging for her product with a team overseas, she can take a photograph with her smartphone and insert it into the stream. The other participants can see the image and add notes and flags to it. Later, a colleague who was unable to attend the meeting can view the image of the new package and listen to the ensuing discussion and notes from the participants. As discussed in more detail below, that image may also be used to mediate a series of conversations in which the same image is used, to tie together all of those conversations for later review or analysis.

A participant may have a comment to make on a topic that has previously been discussed while the mainstream of the conversation has moved on to another topic. Despite that, it is a simple matter to scroll back to the previous topic and add a note. Nothing constrains the participant's navigation during an active session or meeting. This type of interaction is also available after the active session ends. Commenting, correcting, adding information or taking notes on a conversation can happen at any time.

Notes, flags, tags and comments can be made “Private” at the election of the participant adding these annotations. That option is elected by using a check box or radio button 162 shown in FIG. 5. Moreover, some but not all of these annotations can be maintained private while the remainder are public for the others in the conversation. Still further, these annotations or some of them can be semi-public by selecting those in the conversation permitted to see them as they are added by the participant with control over that function. This feature can be linked to the level of authorization afforded different participants. For example, if a representative of Acme joins the conversation concerning the sales to that company, her permissions may restrict her ability to observe comments and the like added by members of the company sales team. And, if she later is authorized to listen to the recorded audio stream, those same levels will apply and thus she will not be able to retrieve or navigate by company added annotations, only the ones she applied during the meeting in this example. In sum, a conversation event and its elements can be partitioned in a manner that allows or restricts viewing of metadata or its use as a navigational tool, where that partitioning is based on the authorization accorded each participant or subsequent reviewer.

It may be important or essential to alert meeting participants to the fact that the conversation is being recorded. For example, privacy laws in some jurisdictions can affect this requirement. In addition to an audio alert that can be broadcast as participants join the meeting, a symbol 163 best viewed in FIG. 5 can signify this condition as a visual cue in addition to any audio cue. The visual notation can become a permanent part of the final record of the conversation event if at a later time it becomes important to show the warning was given.

The meeting host has a number of other variables she can control during the meeting, such as those enumerated in block 167 in FIG. 1A. These include the ability to mute the conversation, to disconnect participants or selected ones of them from the audio and/or web sessions, to share her screen with another meeting participant as also shown in block 138 in FIG. 4, to add and/or advance a presentation, to add and/or advance the agenda, and other useful choices to facilitate the conversation under the control of system control 104.

Throughout the conversation, system control 104 synchronizes the web and audio sessions for real time communication between and collaboration among the participants, as shown generally in FIGS. 1A and 1B. The system records voice communications, web activity, shared documents and other documents, images and objects which became a part of the overall conversation. The system collects and/or creates metadata concerning the web and audio activities and likewise synchronizes that metadata with the recorded voice stream, along with the associated collaborative data, documents and images.

During the meeting, the host or any other participant with proper authority may pause the recording so an unrecorded (e.g., “off the record”) discussion may ensue. There may any of a number of reasons why the host may desire to exclude a part of a conversation from the audio record. This pause feature is elected via button 164.

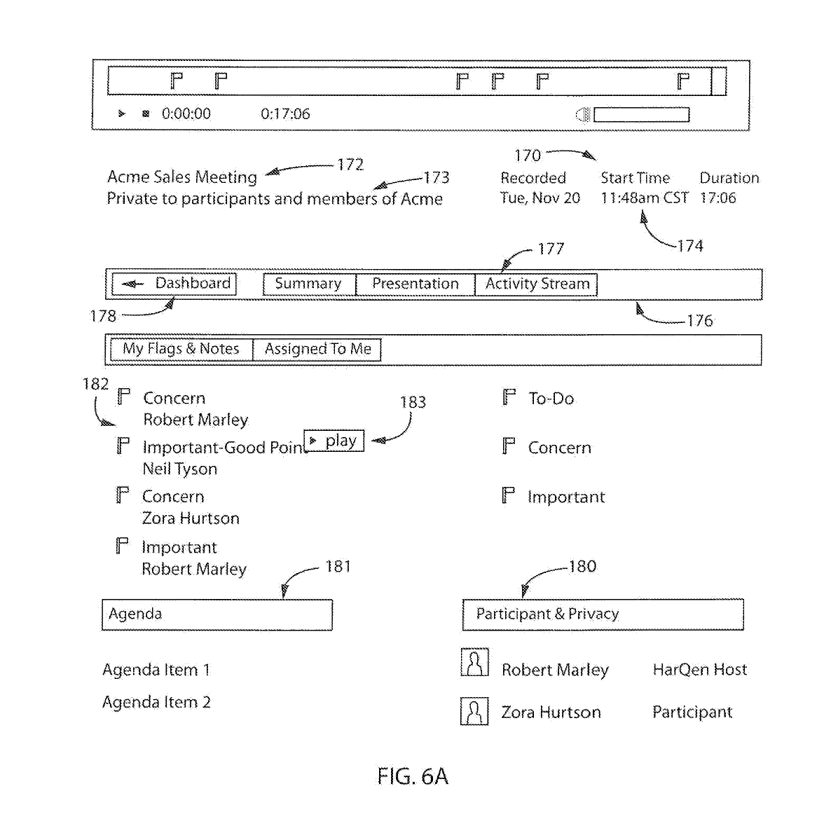

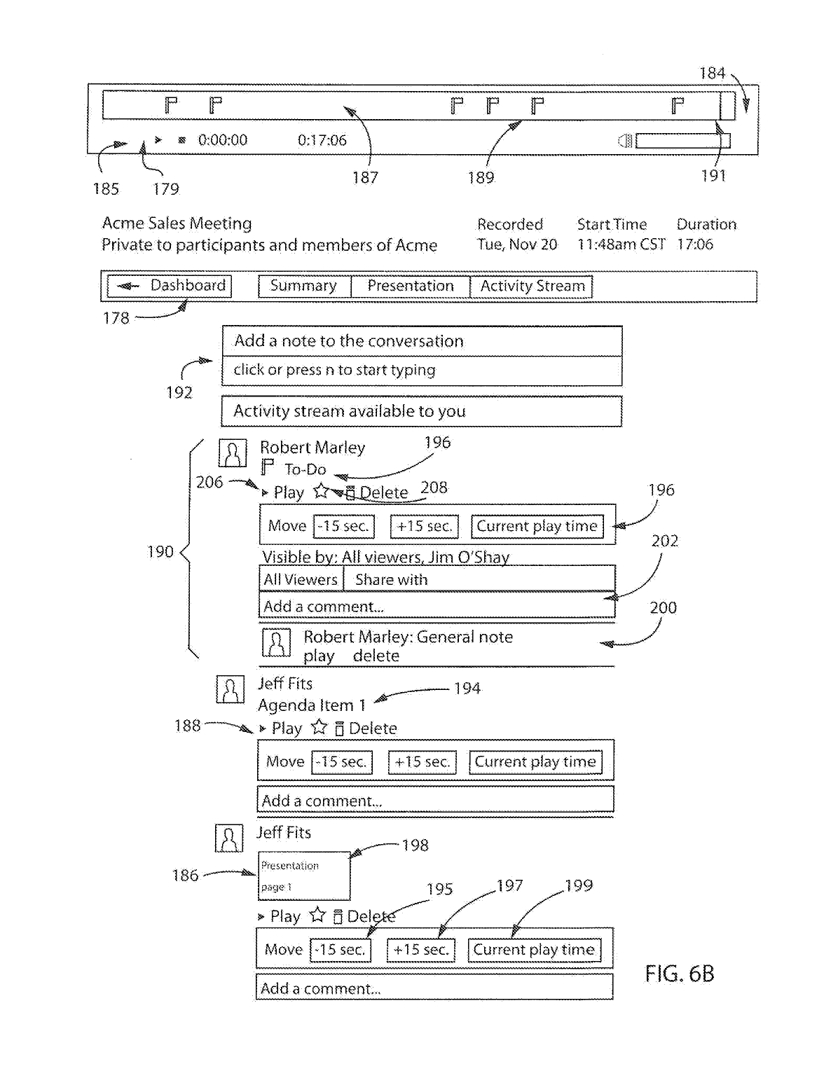

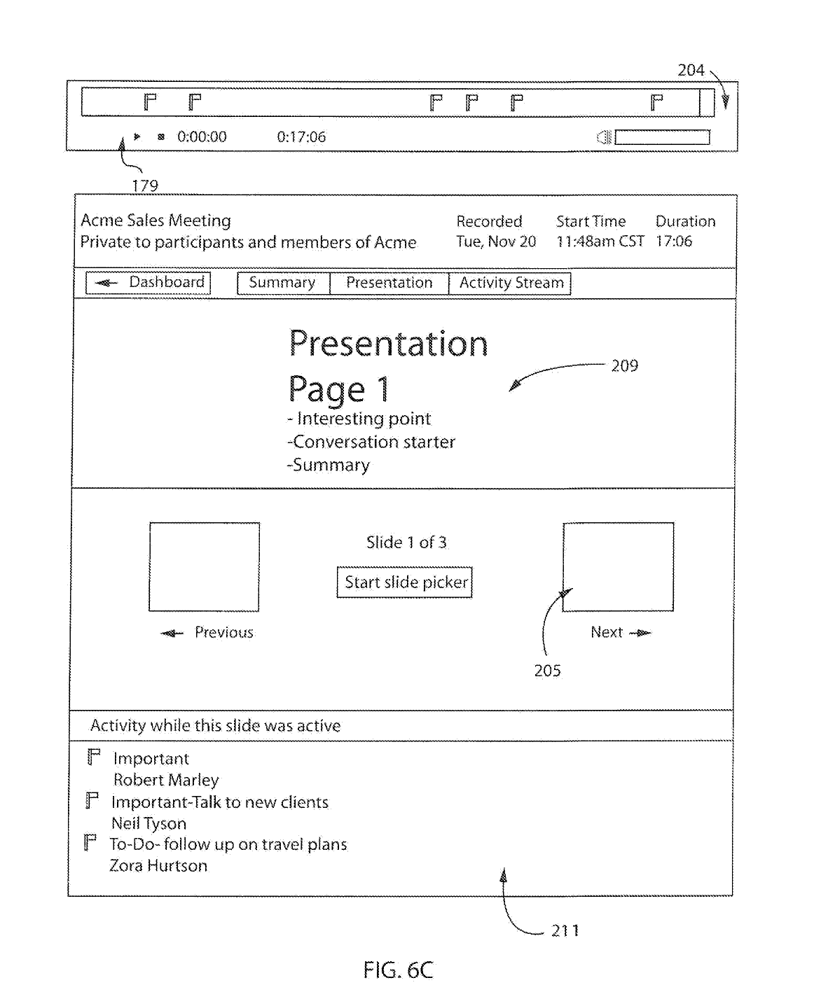

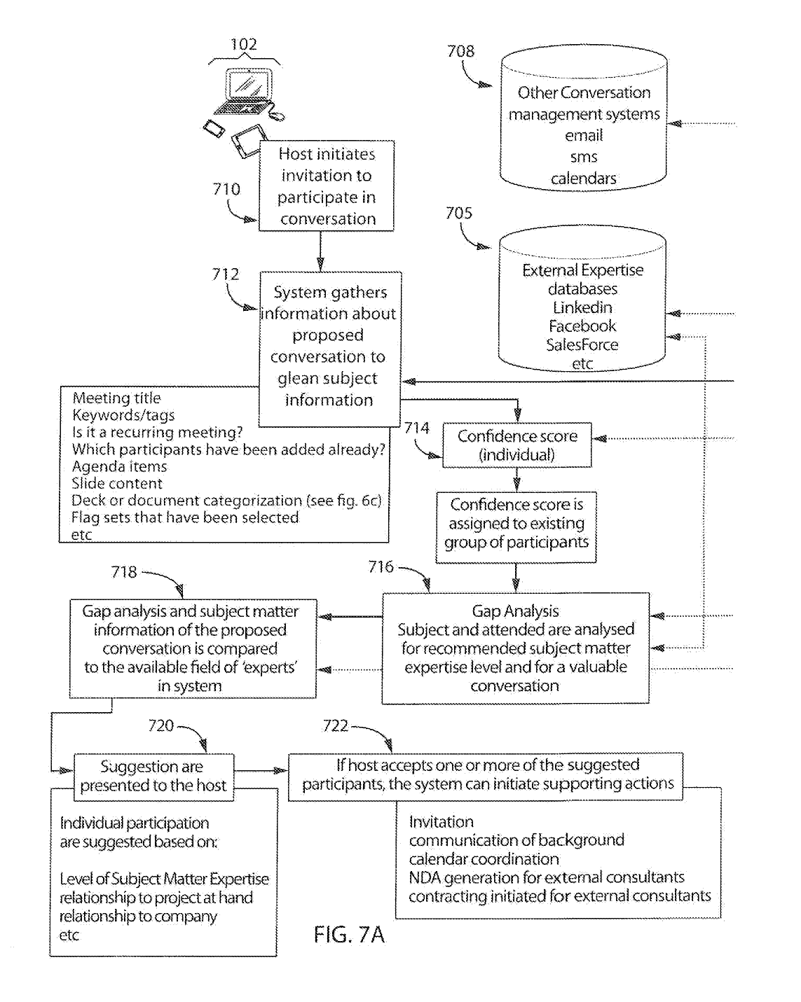

At the conclusion of the meeting, the host may end the meeting and its recording using button 166. Upon the conclusion of the meeting the recorded audio stream is saved by the control system 104, as for example on a server. That recorded audio stream may be accessed by anyone with privileges or authorization to do so. FIGS. 6 and 6A illustrate the windows that become active when access is granted.

FIG. 6A shows an activity window 170 for the previously recorded Acme Sales Meeting. A field 172 shows the name of the meeting while field 174 displays the date the recording was made, the time it started and its duration. The reviewer, who may or may not have been either host or participant when the conversation occurred, has several choices of how he may navigate through the recorded audio stream. The choices are presented in window 176, and include reviewing a summary, or a presentation of the actual activity stream, that activity stream shown in part in FIG. 6A and described in greater detail below in the screenshot of FIG. 6B. The reviewer may also opt to go back to the dashboard on his accessing device via window 178, which in this mode will list all of the recorded audio streams to which he has similar access.

The “Summary” page shown in FIG. 6A includes three major windows. The first, 180 (FIG. 6A), lists the participants in the conversation by name and organizational affiliation. The window is provided with the option to include a photo thumbnail of each participant as well. The second window 181 in this example shows the meeting agenda. The reviewer can navigate from window 181 to any desired agenda item by using his pointing device, such as a mouse or its functional equivalent, and be taken directly to that segment of the audio stream where the desired agenda item was discussed. The third window 179 is a visual representation of the audio timeline 187 including icons to represent events and flags 189 and playback tools to facilitate navigation and review. The reviewer is also presented with the option in window 176 to navigate to presentation materials discussed during the recorded conversation and likewise locate within the entire audio stream those segments or snippets where the presentation materials or a subset of them had been discussed as in FIG. 6C. In the present example, the reviewer chooses to navigate to the “Activity Stream” itself, a portion of which is reproduced in FIG. 6B.

The Activity Stream is designated generally as 184 in FIG. 6B and is comprised of a series of separated windows 186, 188, 190, 192. The timeline in this example is from bottom to top, so the conversation progresses from that associated with window 186 toward window 192. Each window includes a heading identifying in this instance the agenda item under consideration shown as headings 194, 196, 198. Turning to window 190 as exemplary, it is composed of several embedded windows 200, 202 and 204 in this example. As with the overall temporal theme of the annotated audio stream, the conversation associated with window 200 precedes that for 202, and so forth.

Each separate window such as 200 contains a comment inserted by a participant in the conversation. In this example, the reviewer can observe the comment, who recorded it and optionally the thumbnail picture of the person doing so. The reviewer, once again using his pointer, can navigate to the snippet in the audio stream by “clicking” on the comment box itself, whereupon the audio being recorded when the comment was made will be selected by the CMS and replayed for him to hear. Alternatively, the reviewer can navigate to the broader topic that captures all of the comments by activating the “Play” button 205 whereupon he will hear the longer section of the audio stream. As another alternative, the reviewer may use selections within window 206 to navigate specific lengths of time, in this example 15 second increments.

A reviewer may add his own annotations via a “Like” button or an associated panel of flags or tags or by contributing a comment via window 207.

The “Presentation” page shown generally as 208 in FIG. 6C shows the individual slides in an embedded presentation 209, as well as a means of navigation to other slides in the presentation 210. When viewing in individual slide in 209, the user can see any other action that took place during that slide in window 211. The reviewer can also see and listen to the audio that occurred during that slide using the timeline and controls in 179 (FIGS. 6A, 6B and 6C)

The system control 104 captures the two sessions, web and audio, as illustrated generally in FIG. 1A. Respecting the web session, the system records the names (and affiliations if appropriate) of those participants connected to the web session, accounting information if appropriate, who is speaking at a particular time during the conversation and the duration of that speaker's comments, the identity of documents being shared, presentation slides and their temporal order during the conversation and the flags, tags and comments. Respecting the audio session, similar information is collected and synchronized. The entire recorded conversation comprised of audio streams, metadata, documents, images and other objects which are a part of the meeting is then captured as a voice conversation event 212 depicted in FIG. 1B.

As the CMS aggregates many audio files of conversation events along with the elements associated with each, such as the metadata applied either automatically or by those with authorization to do so as well as documents, images or other conversation event elements, the universe of recordings and their elements becomes a fount of valuable information and data that can be analyzed and from it important intelligence revealed. There is a type of network effect at work, whereby the increasing use of the CMS adds to its value thereby creating incentives for still more use. As the CMS houses more data to mine, the correlations, inferences and hard intelligence improves in both quantity and quality. In turn, enterprise efficiency improves dramatically.

The foregoing describes the CMS as it is constructed and functions, using a sales meeting as a working example. Below we describe several variations on this general theme to illustrate additional features incorporated into the CMS at the election of the skilled artisan.

### Example 1

### Subject Matter Expertise

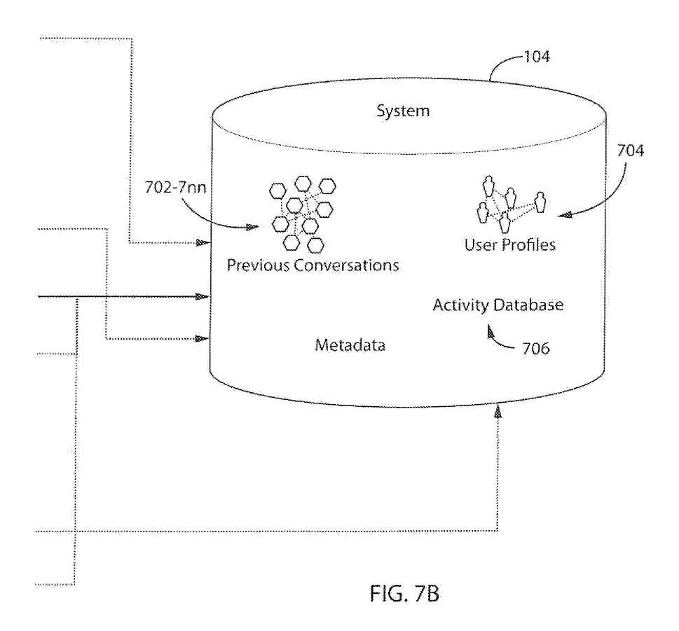

The CMS coordinates a meeting as described in detail above. The system is aware of invitees and agenda prior to the meeting through the meeting invitations and uploaded agenda along with any other documents and/or images (conversation event elements) added to the file by the meeting host. The system also has access to several ancillary databases that can be interrogated to coordinate the same with the subject matter likely to be discussed. (See example below in Table 1A.) The CMS also includes heuristic algorithms that allow it to adapt over time and refine the accuracy of these features. An example with reference to FIGS. 7A and 7B will illustrate these features of the CMS.

The control system 104 shown in FIG. 7B stores all prior conversation streams emanating within an organization as discrete audio files or voice conversation events designated generally as 702-7nn. The conversation event database builds over time and may grow to house years of voice conversation events and their associated or embedded conversation elements. Each is separately identified as described above, with a heading associated with a particular meeting such as Acme Sales Meeting, the date and time of the meeting and its duration, and the meeting participants, such as the information depicted in FIGS. 6A and 6B. In most cases there will also be conversation event elements such as an agenda and/or other textual materials captured as part of the preserved audio file along with the voice conversation event stream annotated with notes, comments and other metadata such as flags and tags as depicted in FIGS. 6A, 6B and 6C.

TABLE 1A

| | Title of | | | | Agenda | |
|---|---|---|---|---|---|---|
| # | Conversation | Participants | Recurring? | Day/time | Items | Flag set |
| 1 | Cockpit | Ken, Adam, | NO | Wednesday/ | Background, | Engineering/ |
| | Configuration | Mark, Asha, | | 9 AM | Client | Design |
| | update | Payam | | | requests, | |
| | | | | | Timeline, | |
| | | | | | Discussion, | |
| | | | | | Budget | |
| | | | | | considerations | |
| 2 | Sales update - | Anthony, | Yes | Thursday/ | (from | Sales |
| | Europe | Rex, Laurie, | | 4 PM | template); | |
| | | Marc, Ken, | | | New leads, | |
| | | Pehr | | | Closed this | |
| | | | | | week, | |
| | | | | | Pipeline, | |
| | | | | | Forecast | |
| | | | | | comparison | |
| 3 | Airfoil Stress | Ken, Adam, | NO | Saturday/ | NONE | Engineering |
| | review | Brooke | | 9:16 PM | | |
| 4 | Electrical | Ken, Adam, | No | Monday/ | Progress | Engineering |
| | System update | Matt | | 11:30 AM | report, | |
| | | | | | Concerns, | |
| | | | | | Budget, | |
| | | | | | Changes | |

Table 1A illustrates four pending meetings created through the CMS along with basic information concerning each one. From this simple set of data in Table 1A, CMS 100 can predict the relationships and expertise of participants as well as the nature and content of the conversations. These patterns can also be informed by the User Profiles (704) and be used to update the expertise and performance of the individuals.

For example, the control system 104 has the data to create meeting categories based on meeting titles, agenda items and flag sets. Conversation #2 has the following clues:
Sales in the title of the meeting
Using the flag set created for sales meetings
Terms like, “leads, closed, pipeline, forecast” in the agenda

From this, the CMS can determine with high probability that this is a meeting relating to sales. This can be done, for example, by having a thesaurus of words related to different conversation categories (e.g. Sales) and by establishing a score for each conversation with respect to each of the categories that may be used in a ranking process. For example the term frequency-inverse document frequency technique of the thesaurus words may be used to rank the likely categories in a manner analogous to that used in search page rankings. As there are no other agenda items, there is a strong inference that this is exclusively a sales meeting. The CMS can compare this conclusion with the User Profile database and information about the participants (e.g. job titles, etc.). A mismatch between rankings of the user profiles (using a similar technique as described above) and a ranking based on agenda items can be used to indicate a ranking error.

By updating patterns in these interactions, the CMS can strengthen the “knowledge” of the system. For example, experimental re-rankings can be done de-weighting individual ones of the words of the thesaurus to see if a better match can be obtained and if so the thesaurus may be adjusted to remove words that create a mismatch or to give them a lower weight. By using the mismatch value, a confidence can be established. For example, the CMS can project with a higher degree of confidence that any meeting that involves Anthony, Rex, Laurie, Marc, Ken or Pehr will likely contain information that is relevant to sales.

Similarly, it becomes more apparent that:
Conversations 1, 3 and 4 are using the flag set for “Engineering”.
Conversations 1, 3 and 4 also include Ken and Adam as common participants.
Meeting 3 started at an odd time and had no agenda therefore it is likely an unscheduled meeting
Meeting 3 took place on a Saturday night so it is probably a high priority or emergency meeting.
Meetings 3 and 4 each contained only one participant other than Ken or Adam
   From this the CMS can increase the confidence that Ken and Adam are likely valuable experts on the engineering team.

Dealing more generally with the ability of the CMS to act predictively concerning subject matter expertise, each individual within an organization contributes to an SME or “Subject Matter Expertise” database based on User Profiles 704 in FIG. 7B. The database will include in addition to name, each person's degrees, awards, work experience, skills, licenses, disciplines, hobbies and other data that pertains directly or indirectly to that person's knowledge, experience, skills and abilities. The data contributions may fall into two general categories, such as “relevant” and “irrelevant.” Relevant expertise deals with such matters as technical competence in the individual's field, for example degrees and work experience. Irrelevant expertise might deal with hobbies or activities outside the norm of technical or business acumen, but which might be called upon in a variety of situations, such as expertise in sailing that could be useful when considering airfoil design. The SME database may also access external sites such as common social networking sites shown illustratively as 705 in FIG. 7A.

The SME database can be updated at any time to refine any of these or other pertinent qualifications or characteristics. Other members of the organization with permission to write to the database can also make contributions, such as peer review and peer recommendations. These might include projects on which the person or departments in which he has worked, a series of job descriptions over the person's tenure with the organization, merit achievements and the like. The organization's SME database may optionally also draw from and contribute to a public version of an individual's SME database. The public SME information could be managed by the individual and maintained in a place that remains persistent over an entire career and/or many employers. (e.g., LinkedIn or a similar information source).

An Activity Database 706 complements the SME database. The Activity Database is driven by an activity algorithm, based on an individual's behaviors and accomplishments within the reach of the CMS across the entire organization. Many SME “promotions” (i.e. becoming a more qualified subject matter expert) are long-term as are quantitative accomplishments like earning a degree, receiving a job promotion, etc. The activity database is intended to track the incremental daily activities of an individual as s/he gains experience in the process of participating in activities around a discipline. These may include, for example, previously attended conversation events recorded and stored by the control system 104. When those activities are added, the Activity Database then includes entries corresponding to the subject matter of those recorded events, the identities and expertise of the other conversation participants, the participation level by the identified person (for example, spoke a certain percentage of the audio stream) and the apparent influence that person exercised or exerted. Each of these factors and others pertinent to the desired activity may be weighted or unweighted at the desire of the artisan setting up the CMS in accordance with the principles set forth herein. The intention is to apply real-time collaboration experience as a contributor to an increase in an individual's expertise.

The control system 104 also has access to other conversation management systems grouped collectively as 708. These other systems include, for example, email files, sms messages and calendars for the personnel within the broad ambit of the databases 704 and 706.

### SME Activity Database Example

In this example illustrated in Table 1B, Robert Marley is an Engineer who specializes in airfoil design. Most of his experience has been in rotor design, but lately he has been involved in some experimental projects working on fixed wing airfoil design.

TABLE 1B

| | | Weighted* SME value | |
|---|---|---|---|
| Activity | SME categories | by category | Notes |
| Participated in | Airfoil engineering- | (AeFW = +12) | |
| engineering client | Fixed Wing(AeFW) | | |
| meeting about fixed | | | |
| wing project | | | |
| Presented team | Leadership(L), | (L = +4), (AeFW = +12) | Presenting to the |
| findings to | Airfoil engineering- | | board increased Bob's |
| executive team in | Fixed Wing(AeFW) | | leadership SME score |
| open board meeting | | | and his Airfoil |
| session | | | engineering-Fixed |
| | | | Wing SME score |

*Weighting could be determined by individual participation in the conversation event being logged. In one conversation, Bob may speak for 30 seconds during a 10 minute, weekly meeting with lower level engineers. This would give him a lower weighted score for that activity than one where he spoke for 15 minutes during a 30 minute meeting with senior level engineers, members of the executive team and clients.

For example, in an engineering meeting concerning airfoil design, in which a particular invitee had entries in both the SME and Activity Databases, the CMS would compare the self-described expertise found in the SME with the meeting agenda and then scan the Activity Database to determine whether and to what extend the same individual was recorded as having participated in one or more other conversations. The Activity Database would be queried for how many such conversations were found within the saved audio streams of voice conversation events and how often they occurred, whether and to what extent the conversations included airfoil subject matter, who else attended those prior meetings and how often and how long the subject individual engaged in the recorded conversation. Based on this scan of the Activity Database and the entries in the SME Database, the subject individual is accorded a “score” that is a baseline for his likely contribution to the scheduled meeting.

The CMS may also integrate with other data systems to retrieve information about the subject individual. This may be a deep integration with networking sites like Facebook or LinkedIn or a process of scraping information from webpages that may be pertinent to his subject matter expertise.

The CMS repeats this series of evaluations for each invitee and compares the scores with each agenda item identified in the meeting invitation. Any of a number of recommendations or comments may be generated by the CMS and sent to the meeting organizer or host. For example, the CMS scores for meeting participants may suggest the absence of important or essential subject matter expertise. Along these lines, a meeting of engineers involving the airfoil subject matter may include an agenda item concerning a marketing topic. The CMS review of participants and their subject matter scores based on the SME and Activity Databases will determine the lack of expertise concerning marketing subject matter using conventional gap analysis principles. A message may be autogenerated by the CMS to the meeting organizer alerting her to that gap between agenda items and subject matter competence, so she can alter either the agenda or composition of the meeting invitees. If the latter, the CMS may offer suggestions based on an examination of personnel with marketing expertise and calendar openings at the time the meeting is scheduled or calendar openings proximate the meeting time.

Just as the CMS has the capability to scan subject matter profiles of company personnel, it may also make recommendations of company outsiders who could round out the expertise profile for a particular meeting. The company may include in its internal database the same profile information for consultants, contractors and agents as it maintains for its employees. The CMS may scan information available on the Internet for other persons not having profiles in the databases, such as social networking sites, blogs, webpages published by experts in their fields of endeavor and make recommendations that one or more of these outside experts be invited. When doing so, the CMS will scan the company's contract database to ascertain whether there is an open confidentiality and/or intellectual property agreement with each invitee and if not flag that for the meeting organizer so she can take necessary steps consistent with company policies.

Summary—Compares user profiles, with subject of conversation to determine optimum makeup of participants.
Host initiates an invitation to one or more people to participate in a conversation. Block 710, FIG. 7A.
System gathers information about the proposed conversation with the intention of determining the subject of the call. Block 712, FIG. 7A.
   a. System analyzes the current conversation invitations for indicators of the subject matter of the proposed conversation.
      i. Meeting title
      ii. Keywords/tags
      iii. Is it a recurring meeting?
      iv. Which participants have been added already?
      v. Agenda Items
      vi. Slide or presentation content
      vii. Deck or document categorization
      viii. Flag sets that have been selected
      ix. Manual input
   b. System queries CMS databases and for historical patterns and associations based on current conversation/invitation information. (see table [1C] below)
   c. System compares this to a set of defined areas of expertise that may be:
      i. Manually defined by manager or company (or)
      ii. Drawn from an international set of standard expertise categories (or)
      iii. Inferred by the System
   d. System determines subject of the call
   e. System derives a “confidence score” that indicates the degree of confidence in the meeting composition. Block 714, FIG. 7A.
System performs a gap analysis (blocks 716 and 718) and assigns a confidence score to the current set of participants based on the likelihood of a productive conversation about the given subject matter. This determination is based on:
   a. The professional attributes of the current attendees' User Profiles
   b. The subject of the proposed conversation
System suggests additional participants to consider (block 720) including in the conversation. If no participants have been selected, the System may suggest a prioritized list of participants based on a variety of criteria such as:
   a. Subject matter expertise
   b. Network relationship to the host
   c. Relationship to the project at hand
   d. Relationship to the company
The additional participants are presented to the host including relevant supporting data to illustrate why they are being recommended
If host accepts one or more of the suggested participants (block 722), the system can initiate supporting actions including:
   a. Sending of an invitation to the new participant(s)
   b. Communication of any background that may be helpful to the conversation
   c. Calendar coordination
   d. NDA generation for external participants that are not already under NDA with the company
   e. Contract initiation for external consultants

### Example 2

### Host Prompting

The control system 104 shown in FIG. 7B stores all prior conversation streams as discrete audio files designated generally as 702-7nn described in connection with Example 1. In most cases there will also be conversation event elements such as an agenda and/or other textual materials captured as part of the preserved audio file along with the voice conversation event stream annotated with notes, comments and other metadata such as flags and tags. All of this metadata may be mined to provide useful guidance.
a. When the host first initiates a meeting and issues invitations as described in connection with FIGS. 2 and 3, the control system 104 is programmed to scan all other audio files 702-7nn to capture correlated subject matter. For example, the control system 104 scans all other agendas to determine whether and to what extent prior meetings addressed the same topics. This may be accomplished by screening prior agendas and scanning for the same or similar keywords between the current and previous agenda items. The control system may identify statistically unique words and select audio files based on that criterion. Similarly, participant listings are examined to determine which other meetings were attended by each invited person and also which meetings were attended by groupings including two or more of the invitees and ranked according to the groupings. For example, if the Acme Sales Meeting invitation list is sent to ten persons, the control system 104 will set separate groupings of any two through as many persons as have attended a meeting together in the past irrespective of the agenda topics, such that a list is compiled for Group 2 (two common persons) through Group x (x common persons) where x is capped at the number of invitees (in this example, ten). In this fashion, one may see how the team has previously assembled and whether there is community of practice that has coalesced around a certain subgroup.
b. The group listings are made solely on the basis of the commonality of participants in prior meetings. The control system 104 also correlates the group listings with agenda topics to determine whether and to what extent the group of invitees to the Acme Sales Meeting have either individually or as a group of two or more addressed the same agenda topics, or any one of them. This cross correlation of people and topics thus identifies prior meetings and the associated conversation streams common with those in the proposed meeting. The data along with identification of the associated audio files stored in the control system 104 is then captured as a new meeting file.
c. The data collected in accordance with this example is then sent to the meeting host so she can determine any of a number of relevant factors. For example, is the proposed meeting likely to provide useful additional information or as likely to be merely duplicative of prior meetings. By listening to the identified audio files and navigating via the metadata tags, flags, notes and comments, she can gain a quick sense of the level of duplication and what new topics or approaches to common topics are likely to be most productive. She can also quickly get a sense of the group dynamics likely to be encountered and how well or poorly this group or a select subgroup interacts and works together. In sum, the materials sent to her by the control system 104 will aid the host's ability to conduct a meeting more efficiently.

### Example 3

### Host Query

Example 2 describes how the control system 104 independently prompts the host with information relevant to and correlated with the meeting she is setting up. In this example, the host may interrogate the control system 104 to extract the same or other useful information. For example, she may set filters on the agenda topics for which she is examining the stored conversation event files, perhaps limiting the search to one or only a few agenda items or certain presentation materials and in the latter case to view and perhaps, at her election, to download them to avoid the need to re-create the same. She may be interested in specific groupings of invitees so set a filter to sort only specific names or specific numbers in a group, such as only groups of 4 or 5 of the same persons she has invited. Once the search has been completed with the filters set to select only the desired information, the host receives a compilation similar to that in Example 2. From that data she may elect to retrieve and listen in whole or in navigated part the audio files she chooses.

### Example 4

### Historical Data

The control system 104 stores all voice conversation events elected by the enterprise in which it is insinuated. These may include not only internally generated conversations or only meetings but also extramural conversations. For example, some companies record all inbound and outbound telephone calls. The CMS of the present invention is uniquely adapted for the management of those conversations as well.

In this example, a member of the Acme Sales team is assigned the task or “to-do” of contacting a person at Acme to gather more information pertinent to the upcoming meeting or to provide information to be communicated to Acme as part of the sales process. When setting up that call, the team member may receive information from the stored conversation event files in control system 104 (as described generally in Example 2) or he may query the control system 104 (as described generally in Example 3). In either event, the team member with this action item is able to locate files containing any conversation or conversation snippet where the Acme contact has participated in any prior conversation. The team member may retrieve and then listen to so many of the recorded snippets to gain an appreciation of the manners and mannerisms of the Acme contact before engaging in the call. Notes or comments associated with the conversation event file as elements within it may alert the team member to any personality issues he is likely to encounter. For example, it may have become apparent through prior conversations with the Acme contact that he does not like to engage in “small talk” or any “off-topic” conversations and prefers to get to the point immediately. The team member will be aware of these preferences either by having been prompted by or searching through control system 104.

### Example 5

### Web Assist

In the course of a conversation, participants may discuss or screenshare websites during a collaboration event. The system can capture or store these web links as part of the conversation summary as conversation event elements. Additionally, the system may capture incremental screenshots of the interaction with the website during the conversation. During a later review of the same link, those reviewers (perhaps participants in a separate conversation) can hear the original discussion around the website as these reviewers are now viewing it live. Additionally, they can record their own comments either as voice or text describing their experience with the reference material which will then be appended to the original conversation. This connection can also be extended beyond an individual conversation event. If a user searches the system for a particular website, the web link will have metadata showing its entire connection to the system. This information may include: conversations in which this web site was discussed, any number of individual or group commentaries on the website and any secondary notes and flags pertaining to the site.

### Example 6

### Documents as Conversation Mediators

In the same manner as described above, any presentation, image, document, etc. can be associated, stored and retrieved by the system. In this example, a PowerPoint® presentation is the central medium.

A conversation invariably has a purpose. It may be as simple as making a presentation or engaging in an exchange so one or more of the parties participating or observing remembers the interaction or some element of it. More often, and especially in a business context, the purpose is to cause or catalyze an action or decision based on the entire content of the interaction. The entire content may include one or more of the array of visual support such as images, video, documents, spreadsheets or even dynamic media such as a website.

Others variables in the spoken audio domain profoundly affect the effectiveness of an interaction or communication. These include vocabulary, cadence, intonation and, when presented live, body language, to identify the most prominent.

The scenario we describe is relevant to any media element used to collaborate, clarify or support voice communication during the course of a conversation or series of conversations. These elements may include (but are not limited to) images, video, text documents, spreadsheets, audio recordings (including sections of the current or previous conversations) screen-shared content, a web application or a website.

For the sake of clarity of our invention, we first describe it in connection with Microsoft's PowerPoint® or (PPT) application which should be familiar to people in business as a means to make multi-page presentations. While there are many ways to create these presentations, Microsoft PowerPoint® is the most prevalent tool to do so in the sales environment. This doesn't mean that the same principles couldn't be applied to any document (spreadsheets, PDF, word does, images, etc.) or other environments.

PowerPoint® is selected for its wide utilization. PowerPoint® is estimated to be used some 30 million times each day to make presentations and has become embedded in, if not as the default means for, a wide range of business purposes. See http://www.thinkoutsidetheslide.com/articles/wasting_{—}250M_bad_ppt.htm. By no stretch of the imagination, PowerPoint® has become the vernacular of business communications. It is also recognized that a significant percentage of those presentations are ineffectual in accomplishing the purpose for which the communication is made.

The use of Customer Relationship Management or CRM tools has accompanied the ubiquity of PPT in business communications. In fact, though originally conceived as a means to track and manage the customer relationship, these database tools are evolving to track and manage the relationships between a company and many others who interact with it. As the relationship between PPT and CRM has developed, the CRM database now keeps track of the PPT presentations intended to cause or catalyze business decisions. In this sense, the pervasiveness of the PPT presentation becomes the key to success in achieving the purpose or aim of the communication and that presentation can now be an embedded element of the CRM. In the context of the present invention, the CRM database may be embedded within the CMS or slaved to it such that the control system has administrative access to or oversight over the CRM. Alternatively, the CMS may function itself as the CRM and thus replace it both functionally and structurally.

Many opine that PPT is not being used effectively. As is often the case, dissatisfaction with a tool is not due nearly as much to its intrinsic limitations but are most often due to the limitations on the abilities of users to apply the tool correctly or even adequately. Additionally, PPT presentations are sparse, abbreviated versions of a presentation devoid of the voice which is typically the core of the actual presentation. We exemplify this aspect of our new invention in summary form as follows:

Document Creation
A PPT author creates a presentation deck in a local or cloud application.
The author publishes it for collaboration and editorial feedback, by circulation such as by email attachment or in a collaboration application.
With or without this first order review, the finished document is then re-published, again directly to selected recipients, the CMS or to a cloud CRM (or other cloud data management environment like SalesForce®, Oracle CRM On Demand® or MS Dynamics®) under control of the CMS.
In the CMS the PPT is available to people, either generally or as authorized for access such as sales presentations, business development, marketing, product development, etc.
The deck may be or become a master deck, such as a master sales deck if the purpose of the presentation or interaction is to accomplish that corporate function, so all of the activities can be analyzed across all presentations of it. This also allows a host to establish a repository to maintain a centralized, accessible/presentable-from-anywhere version of the deck.

Document Presentation
The PPT is also wrapped with the ability to host the presentation in the framework of a conference call, web-collaboration session or web-enabled live meeting. This feature is facilitated by employing our inventions that provide hosting capabilities within a system that manages the voice elements of a communication as well.
The appropriate audience is invited to the presentation (either individually, as a group, in the future, or contemporaneously) via information in their CRM or manually. The invitation is preferably issued through the CMS as described above so all participants may elect to join the voice conversation event using the dashboard that fosters the additions of all manner of metadata, as described herein.
In the process of creating the communication vehicle (phone, phone conference, video call, video conference, web conference, etc.) the host clicks a button and the communication environment is initiated and the presentation is queued up. This communication environment could include a single computer in a conference room or office with or without outside participants.
The host now controls a communication conference environment. (e.g. one-on-one, live in-person, video conference, conference bridge, etc.).
All participants can view the presentation in their web browsers, whether associated with a stationary device or a mobile one such as a smartphone, and join in the conversation with all the other participants. In this fashion, the methodology may be likened to a hosted slideshow or similar communication thereby differing from a conventional “WebEx” or “Go-To-Meeting” screen-sharing product which merely permits the display of the host's computer desktop without any cognitive input on the content or sequencing of those slides or presentation materials.

Annotation and Collaboration
Each participant has the ability to add collaborative (public or private) notes and flags during the presentation.
The host can also add tags, notes and flags during the presentation.
Flags and notes, by whomever added, are applied as metadata that can be public or private and signify locations in or portions of the presentation deemed noteworthy by the person(s) adding the notes or tags.
The conversation event, its elements and the presentation as a principal element are recorded and organized (slides and time-synchronized actions to reference sections of an audio file). Thus, in addition to participant-added notes and tags, the presentation may carry appropriate automatically generated flags, tags and notes.

Review
When the presentation is over, the participants can log in to see and hear the presentation, time-synchronized with their own notes and the public notes of other participants.
The presenter can see basic statistics relevant to the presentation:
   Who participated
   Who presented
   Who spoke
   How many slides
   How long was the meeting
   How much time was spent on each slide
   What areas were called out by flags or notes
   How many flags, notes
   Any other data or observations deemed relevant or important to the presenter or host.

Connecting the Docs

The metadata created during an individual conversation event (described in the previous steps) can be permanently associated to that document in the CMS or CRM. Over time, the metadata from multiple conversations involving or centered on that document can be combined.
After a presentation is made more than once, the metadata associated with that conversation is appended to the overall metadata for that document.
Each statistic can be updated and displayed as a deviation from averages of every other instance when that presentation was made.
Each individual presentation can also be tied to the relevant place or context (contact, opportunity, trouble ticket, account, task etc.) in the CRM. This way, with context-specific information added to the analytical data, the presentation can be further optimized to improve its effectiveness in action.

Presentation Optimization

As is often also the case, the limitations on effectiveness of PPT presentations appear only after the communication or presentation has been made (or after many have been made). We have determined that we can apply the teachings of our inventions to develop heuristics that will considerably improve the effectiveness of presentations such as those made using PPT. As heuristics are obtained and applied, the presentation methods (e.g. timing, emphasis, discussion) of the PPT presentation itself evolve with embedded intelligence and can be highly optimized.
Presenters can see:
   How many times a given PPT has been presented
   Averages for all action statistics
   Who has presented it
   Which slide(s) had the most “objections” across all events
   Which slides are taking the longest on average
   Which slides are being skipped
   Which slides are being shared later
   Which slides are being reviewed more often later
From the audio tracks accompanying the presentation, presenters can hear:
   How different hosts presented a particular slide
   Why a particular slide, for example, is the longest on average
      Listen to all the presentations of that slide
      Are there a lot of pushbacks or other comments or objections raised
      Is it being presented clearly
      Any other discernible information

As the presentation gains a history use over time, still further data and information about it may be gleaned. For example:
Account status and other data can be correlated to presentations to identify patterns.
   Of the number of times a particular deck was used in a selected timeframe:
      How many or what percentage successfully resulted in the desired purpose for having made the presentation
      How many or what percentage resulted in desirable follow-on actions
      How many or what percentage failed to achieve any desired action
      Other data or information that can be extracted to understand the effectiveness of a presentation by content, delivery (i.e., audio presentation in the form of voice overs), context, audience, etc.
         This information can then be used for a multitude of productive purposes:
One may log in to a presentation to prepare for a meeting and study the heuristics to learn:
   This has been presented a certain number of times in the last month. Based on data and intelligence collected and analyzed over that timeframe, it is recommended that the presentation be optimized either in general or for a particular purpose by taking the following actions:
      Remove slide x (skipped in a % of the presentations)
      Remove slide y (skipped in b % of the presentations)
      Remove slide z (skipped in c % of the presentations)
      Shorten the presentation (speaking) in slides r and s (compared to your personal average time presenting these slides)
         Successful close trends (for other presenters) show an average time that is e % shorter on slide r
         Successful close trends (for other presenters) show an average time that is f % shorter on slide s
      You have too many bullets and too many words on slide m
   The hosting platform may then query the presenter with specific cues, such as:
      Would you like to hear the most common pushbacks and highest ranked responses for this deck before you present?
      Would you like to hear the highest ranked ‘close moments’ for this deck?
   This information is tied to the CRM or CMS which both gets and gives information interactively with the presenter as the presentation materials become optimized for the purpose underlying the communication or interaction.

The aspect of the present invention allows a business manager to ask and answer the compelling question of “why?” What in the meetings helps identify success or failure? The answers can be found in the company's CMS/CRM and tied to the lifecycle data of the relationships with presentation participants. The manager can see and hear why. This methodology allows a presenter to identify ways to validate where a presentation is working for its intended purpose, where it is not and ways to remedy the sources of inefficiency. It is fueled by the ability of the system and methods of the present invention not only to collect data concerning voice conversation events and their even elements, but importantly to be able to mine, evaluate and analyze the data and be able to make recommendations based on it.

### Example 7

### Targeted Interest

A person with access to CMS 100 may have either a general or a specific interest in a particular person or persons, either individually or as a group such as those in a community of practice, or in specific subject matter. She may interrogate the control system 104 to identify conversations in which the person(s) of interest participated and retrieve audio snippets of those conversations. The same type of search can be undertaken through the metadata in stored conversation streams 702-7nn to locate subject matter of interest. Alternatively or in addition to the self-initiated search, the searcher may employ a bot to scan audio files as they are stored to search for the same information and then notify her as and when new files are routed to control system 104. In any of these instances, she may listen to whatever snippets she finds interesting based on the parameters she has set for her search.

### Example 8

### Absent or Omitted Personnel

Example 1 deals with the addition of subject matter experts in situations when their participation may be helpful in a meeting. There are other situations when a meeting host realizes a person who can be helpful during a meeting has not received an invitation or that persons not participating in the meeting are required to take actions based on the conversations. CMS 100 is adapted to provide necessary actions.

The meeting host may realize during a meeting that a subject has arisen that was not fully anticipated when the invitations were sent. She may initiate a search in the same manner as described in Example 3 to ascertain who has the appropriate background from personnel listings along the lines of the listing described in Example 1. The control system may scan calendars of those persons she identifies to determine whether any is available to attend the meeting and issue invitations to do so. The omitted individual may respond with his availability and join either in person or via an interface device such as one of the ones shown as 102b in FIG. 1A. If no one is available, the invitation may be converted into an action item for the identified individual(s) and a link to the audio file sent so he may undertake such action as may be required.

In other situations, the host may elect not to invite everyone who is likely to have an action assigned during the meeting. For example, it may be contemplated that one or more participants in the Acme Sales meeting will be required to travel to the customer site. When, during the conversation, the meeting participants turn to the travel item on the agenda, a participant who is required to travel or the host herself may tag the audios stream with a “To-Do” flag associated with the traveler(s). The control system 104 generates a message to the traveler(s)' administrative assistant or to the travel coordinator along with a link to the pertinent snippet in the conversation stream so necessary and appropriate travel plans can be made. This feature of the present invention avoids the need to have those personnel attend an entire meeting simply to be present during a small portion of it pertinent to their normal duties in the organization. The savings in time (and associated corporate costs) should not be underestimated when considering the wasted downtime of meeting attendees.

### Example 9

### Standby Participants

Much like the situations described above and particularly with reference to Example 7, there may be meetings in which some person(s) will participate during only a selected portion of it. For example, in the Acme Sales meeting, there may be an agenda item concerning prior contacts with that customer. The person(s) having the best or relevant knowledge may be invited to participate but only during the conversation concerning that agenda topic. The meeting invitation may set authorization for participation only when that topic comes up for discussion. At the appropriate time, the CMS will issue a notice and the standby participant(s) may join or it may elect to call the participant(s) required to address that topic, all as described above. If the standby participant(s) will join via an interface device (e.g., 102b) rather than in person, the interface device(s) will receive the invitation and with a privilege setting that allows participation only during the time when the identified topic is being discussed. The participant(s)' interface will be enabled with all or as many of the options on the dashboard as the host authorizes. The Standby Participants' participation in the conversation can continue to the end of the conversation or may be automatically revoked by the CMS at the end of the agenda item or manually by the host.

### Example 10

### Heuristics

Because the CMS has oversight and insight respecting all voice conversation events within its permitted purview, it has ever-expanding access to audio files stored in the control system 104 on an ongoing basis. It may be programmed to find correlations and make inferences as more metadata becomes available. At the highest level, the CMS may collect data concerning agendas, presentation materials and participants and begin making inferences about who is most active in a variety of areas or topics, for example those who regularly attend meetings devoted to technical topics such as airfoil design. Comparing the databases of personal characteristics such as those described in Example 1 and the topic of airfoil design, the CMS may initially infer additional characteristics about the individual who attend these meetings.

Delving deeper into the metadata from those meetings concerning a specific topic such as airfoil design the CMS can identify the activity of each participant based on the percentage of time each spoke or another determinant of participation.

Cutting still deeper into the metadata associated with these meetings, the CMS can determine who is most active in contributing notes and comments and the extent of those comment strings by examining the number of comment windows either added by a participant or added by another while a particular person was speaking. Along similar lines, the CMS may examine the metadata associated with flags and tags and by category. For example, if there are many notes or comments associated with a particular participant and flags indicating interests on the parts of other meeting participants, the CMS can make inferences about the leadership status of each meeting participant. Over time these inferences can be refined with new data as more conversation streams are added via the audio files in control system 104.

Those with permitted access to the control system 104 and the correlation/inference data it houses may interrogate that data to extract useful information that can be used when setting up other meetings or for promotions.

Table 2 illustrates how data may be extracted from the CMS to identify the characteristics of likely participants when a meeting agenda includes “airfoil” as a topic or agenda item. In this example, the CMS surveys all voice conversation event files where “airfoil” was discussed, was an agenda item or topic or where materials associated with a meeting included “airfoil” such as in a PowerPoint® presentation. For each conversation/meeting/audio file within the scope of the search filter, a universe of personnel is identified. Accompanying their identities the CMS breaks out selected data sets specified by the searcher or generated by the CMS based on search criteria inputted by an interested party with access to the database. These data sets are, respectively, the number of meetings each attended where airfoil was an agenda item, the percentage of all meetings in the database these represent, how long each person spoke during the meetings, the average number of flags each person inserted into the accompanying metadata stream and the average number of textual notes or comments each person contributed to the metadata stream as well.

TABLE 2

| | | | | | | Average |
|---|---|---|---|---|---|---|
| | | | | | | number of |
| | | | | | | notes or |
| | | % of total | Average length | | Average | comments |
| | # of meetings | meetings | of time spent | | number of flags | inserted into |
| | attended where | attended where | speaking during | | inserted during | audio stream |
| | airfoil discussion | airfoil is an | airfoil agenda | | airfoil | during airfoil |
| | is an agenda item | agenda item | item | | conversations | conversations |
| Joe | 23 | 97% | 7 | minutes | 12 | 21 |
| Rex | 3 | 14% | .25 | minutes | 0 | 6 |
| Alissa | 17 | 55% | 1 | min | 0 | 9 |
| Reiley | 12 | 19% | .005 | minutes | 0 | 0 |

A simple example in the table above illustrates how the system can determine, based on data from multiple conversations, who should participate in a conversation about a new airfoil design project. Joe is a clear candidate as an expert on airfoil design.

TABLE 3

| | # of meetings | % of total meetings | Average length |
|---|---|---|---|
| | attended where | attended where | of time spent |
| | catering discussion | catering | speaking during |
| | is an agenda item | is an agenda item | catering agenda item |
| Joe | 0 | 0% | NA |
| Rex | 2 | 65% | 1.25 minutes |
| Alissa | 12 | 92% | 11 minutes |
| Reiley | 3 | 6% | .35 minutes |

Table 3 illustrates, that Alissa is clearly the person to involve in a discussion about catering a company event.

It will be understood that a variety of different techniques may be used to establish the correlations described above and to enable these heuristics. Techniques such as cluster analysis, correlation, support vector machines, neural nets and the like may be employed.

### Example 11

### Housekeeping

There are many housekeeping duties that fall on a meeting host or organizer that can distract from her participation during the substance of the meeting. For example, a meeting may initially be scheduled for one hour. As the deadline approaches it may become apparent that the host needs another thirty minutes to complete the agenda. The CMS may undertake any of a number of actions. For example, it will examine the calendars of participants to determine whether each has sufficient free time on their schedules that the meeting can be prolonged the anticipated thirty minutes. If that is not viable, the CMS may schedule a follow-on meeting the next time all participants are available. The host may indicate the agenda items that require further discussion and the CMS may determine who may be required and who are no longer required as it undertakes either of the forgoing actions. There is also the question of whether, when at least some of the meeting participants are attending in person in a meeting or conference room, that room is available for the next successive thirty minutes or is scheduled for another meeting. In that latter instance, the CMS may scan the availability of other suitable meeting rooms, taking into account the need for any ancillary devices such as a screen and/or projector and then determine whether the meeting must be adjourned and the room vacated, whether another room with appropriate support devices is available and then either for the subject meeting or the one scheduled right after it. All of this can be accomplished at the speed of modern microprocessors and recommendations made in virtually real time.

While the invention has now been described in detail and exemplified with reference to several specific applications, those skilled in the art will recognize that the system and method of the present invention may be used in whole or in part and may be modified in many ways without departing from the spirit hereof. Thus, it is intended that the scope of the present invention be limited solely by the prior art and the reasonable interpretation of those issued claims defining its metes and bounds.

1. A method for managing a conversation stream being recorded contemporaneously with the conversation in which at least one participant is engaged in a discussion and wherein the at least one participant is communicating with the aid of a computer enabled interface for placing metadata tags, flags and notes in a file associated temporally with the audio stream of the recording, comprising the steps of:
a. recording a live audio conversation in a recorded audio stream created contemporaneously with the discussion among or between conversation participants;
b. generating at selected times contemporaneously with the recording step associated metadata representing specific points of interest;
c. analyzing the metadata to extract management information pertinent to the audio conversation.

2. The method of claim 1, wherein the points of interest are selected from the group consisting of agenda items, invitation list of participants, attending participants, the identities of speakers during the conversation, the credentials of the participants including their subject matter expertise, words spoken and their frequency, and materials used during the conversation event.

3. The method of claim 1, wherein the step or analyzing comprises the steps of:
a. organizing the metadata, and
b. filtering the metadata.

4. The method of claim 1, wherein the placement of metadata is generally time-synchronized with the recorded conversation to allow a reviewer of the recorded conversation to locate specific audio snippets identified with specific metadata.

5. The method of claim 1, wherein a single participant records a conversation event for later retrieval.

6. The method of claim 1, wherein at least two participants are engaged in the conversation event.

7. The method of claim 1, wherein said metadata is autogenerated by the conversation management system.

8. The method of claim 1, wherein said metadata is inserted into a file by one or more participants in the conversation event.

9. The method of claim 1, wherein the step of generating said metadata is comprised of inserting said metadata into a track in the audio file.

10. The method of claim 1, wherein the step of generating said metadata is comprised of inserting said metadata into a separate metadata file associated with said audio file.

11. The method of claim 10, wherein the metadata file is time synchronized with said audio file.
